(19) United States
(12) Patent Application Publication
(10) Pub. No.: US 2018/0065274 A1
(43) Pub. Date: Mar. 8, 2018

(54) METHOD AND APPARATUS FOR FORMING CERAMIC PARTS IN HOT ISOSTATIC PRESS USING ULTRASONICS

(71) Applicant: Lam Research Corporation, Fremont, CA (US)

(72) Inventors: William CHARLES, Los Altos, CA (US); Thomas STEVENSON, Morgan Hill, CA (US); Nash ANDERSON, Campbell, CA (US); Russell ORMOND, San Jose, CA (US); Michael LOPEZ, Redwood City, CA (US)

(21) Appl. No.: 15/255,854

(22) Filed: Sep. 2, 2016

(51) Int. Cl. B28B 11/24; C04B 35/10; C04B 35/645

(52) U.S. Cl. CPC B28B 11/243; C04B 35/10; C04B 35/6455; C04B 2235/661; C04B 2235/612; C04B 2235/656; C04B 2235/667; C04B 2235/3217

(57) ABSTRACT

A method for forming a ceramic object from a ceramic powder is provided. The ceramic powder is placed in a press. Pressure is applied to the ceramic powder with a pressure to cause consolidation of the ceramic powder. Ultrasonic energy is applied to the ceramic powder for at least a period of time during the applying pressure to the ceramic powder, forming the ceramic powder into a ceramic object. The applying pressure to the ceramic powder is ended.

### BACKGROUND

The disclosure relates to a method of forming ceramic parts. More specifically, the disclosure relates ceramic parts used in a plasma processing device.

In forming semiconductor devices a plasma processing device may be used. Some plasma processing devices use ceramic parts that are exposed to the plasma.

### SUMMARY

To achieve the foregoing and in accordance with the purpose of the present disclosure, a method for forming a ceramic object from a ceramic powder is provided. The ceramic powder is placed in a press. Pressure is applied to the ceramic powder with a pressure to cause consolidation of the ceramic powder. Ultrasonic energy is applied to the ceramic powder for at least a period of time during the applying pressure to the ceramic powder forming the ceramic powder into a ceramic object. The applying pressure to the ceramic powder is ended.

In another manifestation, a method is provided. Ceramic powder is placed in a press. Pressure is applied to the ceramic powder with a pressure to cause consolidation of the ceramic powder. Ultrasonic energy greater than 1 W/cm² is applied to the ceramic powder for at least a period of time during the applying pressure to the ceramic powder forming the ceramic powder into a ceramic object. The ceramic powder is heated to a temperature above 1000° C. during at least a period of time during the applying pressure to the ceramic powder. The applying pressure to the ceramic powder is ended. The ceramic object is removed from the press. The ceramic object is machined into a plasma chamber part. The ceramic object is fired. The ceramic object is installed as part of a plasma processing chamber.

These and other features of the present disclosure will be described in more detail below in the detailed description of embodiments and in conjunction with the following figures.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 is a high level flow chart of an embodiment.

FIG. 2 is a schematic cross-sectional view of a mold that is used in an embodiment.

FIG. 3 is a schematic cross sectional view of a press used in an embodiment.

FIG. 4 is a high level block diagram showing a computer system, which is suitable for implementing a controller used in an embodiment.

FIGS. 5A-B are cross-sectional views of a ceramic part formed in an embodiment.

FIG. 6 is a schematic view of a plasma process chamber that may be used in an embodiment.

### DETAILED DESCRIPTION OF THE PREFERRED EMBODIMENTS

The present embodiments will now be described in detail with reference to a few preferred embodiments thereof as illustrated in the accompanying drawings. In the following description, numerous specific details are set forth in order to provide a thorough understanding of the present disclosure. It will be apparent, however, to one skilled in the art, that the present disclosure may be practiced without some or all of these specific details. In other instances, well known process steps and/or structures have not been described in detail in order to not unnecessarily obscure the present disclosure.

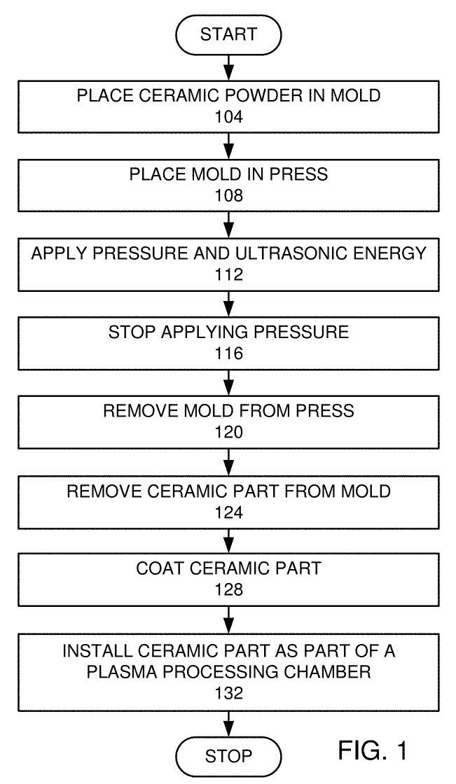

FIG. 1 is a high level flow chart of an embodiment. In this embodiment, ceramic powder is placed in a mold (step 104). The mold is placed in a press (step 108). Pressure is applied to the mold, while ultrasonic energy is also provided (step 112). The application of pressure is stopped (step 116). The mold is removed from the press (step 120). A ceramic part is removed from the mold (step 124). The ceramic part is machined to near net shapes (Green State) (step 128). The ceramic part is fired in a kiln (step 132). The ceramic part is may receive addition machining operations and maybe coated (step 136). The ceramic part is installed in a plasma processing chamber (step 140).

### EXAMPLE

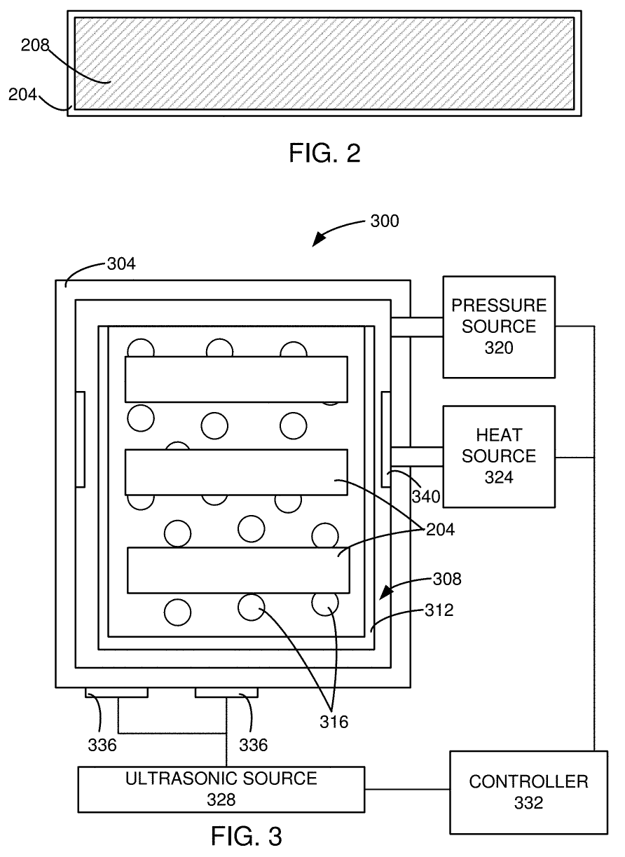

In a preferred embodiment, a ceramic powder is placed in a mold (step 104). FIG. 2 is a schematic cross-sectional view of a mold 204 that is used in this embodiment. The mold 204 has relatively thin walls and is made of a material that is flexible when forming walls of the thickness of the walls of the mold. In this embodiment, the mold is made of compliant materials, such as rubber or plastic. In this embodiment, the mold is made of rubber. The mold 204 is filled with a ceramic powder 208, which in this embodiment is aluminum oxide powder.

The mold 204 is placed in a press (step 108). FIG. 3 is a schematic cross sectional view of a press 300 used in this embodiment. The press 300 in this example is a hot isostatic press with an ultrasonic energy system. The press 300 comprises a pressure chamber 304. Within the pressure chamber is a cage 308. In this embodiment a plurality of molds 204 is placed within the cage 308. In this embodiment the cage is a cylindrical wall 312 with a plurality of apertures 316. The press 300 has a pressure source 320, a heat source 324, an ultrasonic energy source 328, and a controller 332, which is connected to the pressure source 320, the heat source 324, and the ultrasonic energy source 328. In this embodiment, ultrasonic transducers 336 are placed against or in the pressure chamber 304. The ultrasonic transducers 336 are connected to the ultrasonic energy source 328. Additional ultrasonic transducers may be placed in or around the pressure chamber 304. The pressure source 320 provides a pressurized fluid into the pressure chamber 304. Separate devices or a single device may be used to provide the fluid and then to pressurize the fluid. In this embodiment, the heat source 324 provides energy to coils 340 within the pressure chamber 304. In other embodiments, the heat source 324 may be connected to the pressure source 320 to heat the fluid provided by the pressure source 320.

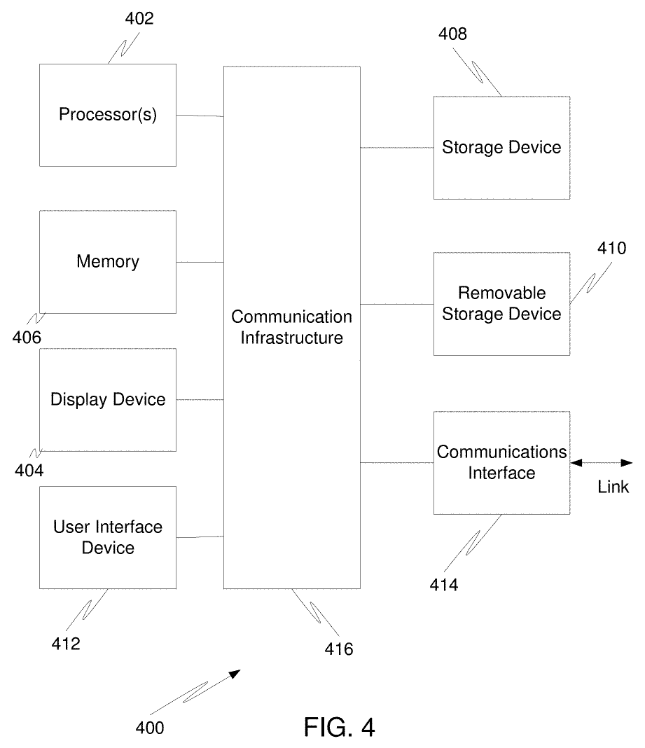

FIG. 4 is a high level block diagram showing a computer system 400, which is suitable for implementing a controller 332 used in embodiments. The computer system may have many physical forms, ranging from an integrated circuit, a printed circuit board, and a small handheld device, up to a huge super computer. The computer system 400 includes one or more processors 402, and further can include an electronic display device 404 (for displaying graphics, text, and other data), a main memory 406 (e.g., random access memory (RAM)), storage device 408 (e.g., hard disk drive), removable storage device 410 (e.g., optical disk drive), user interface devices 412 (e.g., keyboards, touch screens, keypads, mice or other pointing devices, etc.), and a communication interface 414 (e.g., wireless network interface). The communication interface 414 allows software and data to be transferred between the computer system 400 and external devices via a link. The system may also include a communications infrastructure 416 (e.g., a communications bus, cross-over bar, or network) to which the aforementioned devices/modules are connected.

Information transferred via communications interface 414 may be in the form of signals such as electronic, electromagnetic, optical, or other signals capable of being received by communications interface 414, via a communication link that carries signals and may be implemented using wire or cable, fiber optics, a phone line, a cellular phone link, a radio frequency link, and/or other communication channels. With such a communications interface, it is contemplated that the one or more processors 402 might receive information from a network, or might output information to the network in the course of performing the above-described method steps. Furthermore, method embodiments may execute solely upon the processors or may execute over a network such as the Internet in conjunction with remote processors that shares a portion of the processing.

The term “non-transient computer readable medium” is used generally to refer to media such as main memory, secondary memory, removable storage, and storage devices, such as hard disks, flash memory, disk drive memory, CD-ROM and other forms of persistent memory, and shall not be construed to cover transitory subject matter, such as carrier waves or signals. Examples of computer code include machine code, such as produced by a compiler, and files containing higher level code that are executed by a computer using an interpreter. Computer readable media may also be computer code transmitted by a computer data signal embodied in a carrier wave and representing a sequence of instructions that are executable by a processor.

Pressure and ultrasonic energy are applied (step 112). In this embodiment, pressure is applied by flowing water from the pressure source 320 into the pressure chamber 304. The heat source 324 causes the water to be heated. The ultrasonic source provides power to the transducers 336 to provide ultrasonic energy simultaneous with and during the application of pressure and heat.

The application of the pressure is stopped (step 116). In this embodiment, the application of ultrasonic energy is stopped before the application of pressure is stopped. In such an embodiment, the ultrasonic energy may be useful at the beginning of the application of pressure, but not useful after a period of time. In this embodiment, the beginning of the application of the pressure and ultrasonic energy are simultaneous.

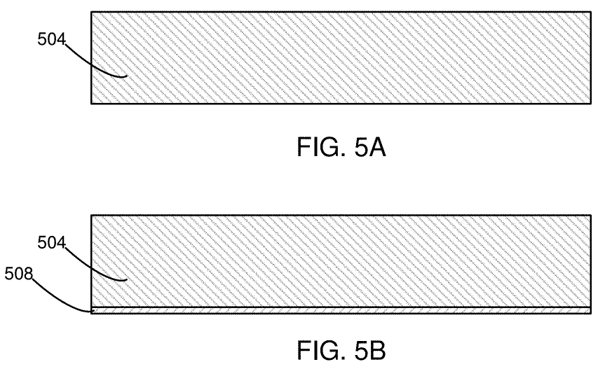

The mold is removed from the press (step 120). A ceramic part formed from the ceramic powder is removed from the mold (step 124). FIG. 5A is a cross-sectional view of the ceramic part 504 after the ceramic part is removed from the mold. In this embodiment, the ceramic part is in the form of a cylinder. The ceramic part 504 may be subjected to machining, such as grinding, polishing, or drilling holes in order to shape the ceramic part into a desired shape (step 128). The ceramic part is then fired in a kiln (step 132), which further hardens the ceramic part.

The ceramic part may be subjected to additional processes, such as placing a coating on the ceramic part 504 or further machining after firing (step 136). FIG. 5B is a cross-sectional view of the ceramic part 504 with a coating 508 on a surface. In this embodiment, the coating is yttrium oxide.

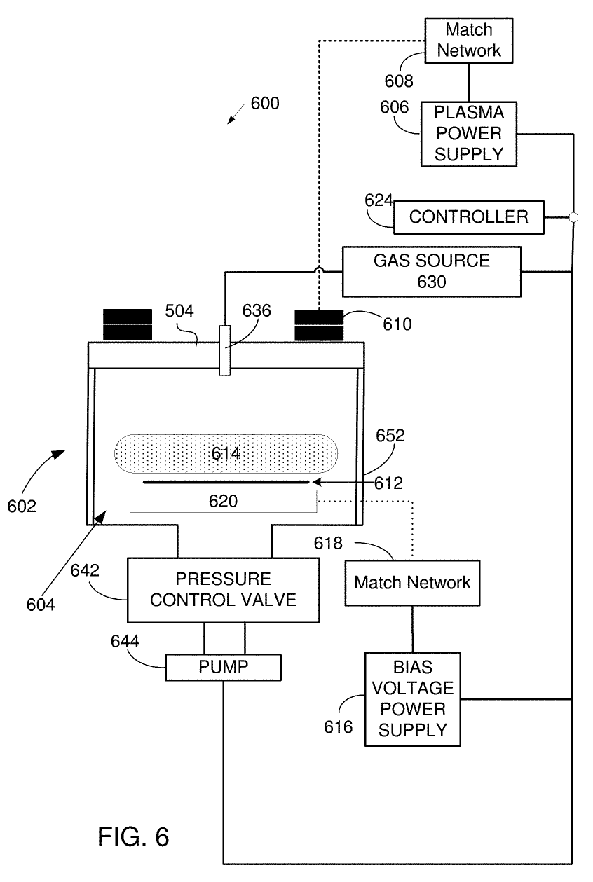

The ceramic part is installed as part of a plasma processing chamber (step 132). FIG. 6 schematically illustrates an example of a plasma processing system 600 which may be used in accordance with one embodiment of the present disclosure. The plasma processing system 600 includes a plasma reactor 602 having a plasma processing chamber 604, enclosed by a chamber wall 652. The ceramic part 504 is used to form a power window. A plasma power supply 606, tuned by a match network 608, supplies power to a TCP coil 610 located near the power window formed from the ceramic part 504 to create a plasma 614 in the plasma processing chamber 604 by providing an inductively coupled power. The TCP coil (upper power source) 610 may be configured to produce a uniform diffusion profile within the plasma processing chamber 604. For example, the TCP coil 610 may be configured to generate a toroidal power distribution in the plasma 614. The power window formed from the ceramic part 504 is provided to separate the TCP coil 610 from the plasma processing chamber 604 while allowing energy to pass from the TCP coil 610 to the plasma processing chamber 604. A wafer bias voltage power supply 616 tuned by a match network 618 provides power to an electrode 620 to set the bias voltage on a substrate 612 which is supported over the electrode 620. A controller 624 sets points for the plasma power supply 606 and the wafer bias voltage power supply 616.

The plasma power supply 606 and the wafer bias voltage power supply 616 may be configured to operate at specific radio frequencies such as, 13.56 MHz, 27 MHz, 2 MHz, 400 kHz, or combinations thereof. Plasma power supply 606 and wafer bias voltage power supply 616 may be appropriately sized to supply a range of powers in order to achieve desired process performance. For example, in one embodiment of the present disclosure, the plasma power supply 606 may supply the power in a range of 50 to 5000 Watts, and the wafer bias voltage power supply 616 may supply a bias voltage of in a range of 20 to 2000 V. In addition, the TCP coil 610 and/or the electrode 620 may be comprised of two or more sub-coils or sub-electrodes, which may be powered by a single power supply or powered by multiple power supplies.

As shown in FIG. 6, the plasma processing system 600 further includes a gas source/gas supply mechanism 630. The gas source/gas supply mechanism 630 provides gas to a gas feed 636 in the form of a nozzle. The process gases and byproducts are removed from the plasma processing chamber 604 via a pressure control valve 642 and a pump 644, which also serve to maintain a particular pressure within the plasma processing chamber 604. The gas source/gas supply mechanism 630 is controlled by the controller 624. A Kiyo by Lam Research Corp. of Fremont, Calif., may be used to practice an embodiment. The plasma processing chamber 604 is used to process one or more substrates 612, which exposes the ceramic part 504 to plasma.

Without being limited by theory, it is believed that the addition of ultrasonic energy to a hot isostatic press in order to form ceramic parts by providing ultrasonic energy during the hot isostatic pressing process reduces the size and number of voids formed during the hot isostatic pressing process. Without the addition of ultrasonic energy, the hot isostatic pressing process forms ceramic parts with voids on the order of 2 microns and a concentration of 3-5 per machined surface. It is believed that the addition of ultrasonic energy to the hot isostatic pressing process of ceramics will reduce the void size and the concentration.

It has been found that ceramic parts with voids created using a hot isostatic press create defects during plasma processing. In addition, during the coating process, voids may be sealed over, creating a bubble in the void. During the plasma processing the bubble may burst creating defects. In addition, such voids cause the ceramic part to degrade more quickly.

The addition of ultrasonic energy during a hot isostatic pressing process reduces voids, which produces ceramic parts that cause less defects and are more durable to a plasma process. In addition, the use of ultrasonic energy during a hot isostatic pressing process decreases the time needed for the hot isostatic pressing process. In addition, a less porous object may have additional benefits, such as being stronger, less internal stress, and denser along with shorter process time (in the HIP process). A stronger object may be made thinner and lighter.

Preferably, the ultrasonic energy is high enough to help the ceramic particles to move into the best packing orientation with the lowest energy state, but low enough so that the ultrasonic energy does not interrupt the pressing process. Therefore the frequency and power provided by the ultrasonic energy is dependent on the ceramic material being pressed.

Additional benefits may be demonstrated in the ability to HIP materials/compounds/formulations previously unprocessable and multimaterials (laminates) found to be difficult with HIP alone. A preferred embodiment would provide ultrasonic energy at the beginning of the pressing process, but discontinued before the end of the hot pressing process. In addition, another preferred embodiment may start providing the ultrasonic energy before the pressing process. However, in embodiments ultrasonic energy is also provided during the pressing process.

In an example, the ceramic powder is less than 10 microns. The ultrasonic energy is provided at 5 watts/cm² at multiple ultrasonic frequencies. In another example, ultrasonic energy is provided at a frequency less than 40 kHz, at a power of between 1 watt/cm² to 20 watts/cm². The energy ranges indicate the energy applied to the ceramic powder. Since the mold may dissipate a substantial amount of the ultrasonic energy, a higher power may be applied by the press, but the ultrasonic energy actually applied to the ceramic powder will preferably be in the above specified ranges. For example a 1,000 watt transducer at the walls of the press may provide 5 watts/cm² to the ceramic powder. Generally, the ultrasonic frequency may be between 20 kHz to less than 1 MHz.

Preferably, the heat source heats the mold to a temperature above 1000° C., while pressure and ultrasonic energy is provided.

In some embodiments, the pressurized fluid is a pressurized liquid. In other embodiments, the pressurized fluid is a pressurized gas. In another embodiment, a heated uniaxial press with the application of ultrasonic energy may be used.

While this disclosure has been described in terms of several preferred embodiments, there are alterations, modifications, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, modifications, permutations, and various substitute equivalents as fall within the true spirit and scope of the present disclosure.

What is claimed is:

1. A method for forming a ceramic object from a ceramic powder, comprising:
placing the ceramic powder in a press;
applying pressure to the ceramic powder with a pressure to cause consolidation of the ceramic powder;
applying ultrasonic energy to the ceramic powder for at least a period of time during the applying pressure to the ceramic powder, forming the ceramic powder into a ceramic object; and
ending the applying pressure to the ceramic powder.

2. The method, as recited in claim 1, wherein the wherein the placing the ceramic powder in the press, comprises:
placing the ceramic powder in a mold; and
placing the mold in the press.

3. The method, as recited in claim 2, wherein the press provides isostatic pressure, wherein the applying pressure to the ceramic powder applies isostatic pressure to the ceramic powder.

4. The method, as recited in claim 3, further comprising heating the ceramic powder to a temperature above 1000° C. during at least a period of time during the applying pressure to the ceramic powder.

5. The method, as recited in claim 4, wherein the ceramic powder comprises aluminum oxide.

6. The method, as recited in claim 5, wherein the ultrasonic energy is applied near the beginning of applying pressure and is terminated before ending the applying pressure.

7. The method, as recited in claim 6, wherein the applying ultrasonic energy to the ceramic powder, provides an ultrasonic energy power greater than 1 W/cm².

8. The method, as recited in claim 7, further comprising:
removing the ceramic object from the press;
machining the ceramic object into a plasma chamber part; and
firing the ceramic object.

9. The method, as recited in claim 8, further comprising coating the ceramic object.

10. The method, as recited in claim 9, further comprising installing the object in a plasma processing chamber.

11. The method, as recited in claim 1, wherein the press provides isostatic pressure, wherein the applying pressure to the ceramic powder applies isostatic pressure to the ceramic powder.

12. The method, as recited in claim 1, further comprising heating the ceramic powder to a temperature above 1000° C. during at least a period of time during the applying pressure to the ceramic powder.

13. The method, as recited in claim 1, wherein the ceramic powder comprises aluminum oxide.

14. The method, as recited in claim 1, wherein the ultrasonic energy is applied near the beginning of applying pressure and is terminated before ending the applying pressure.

15. The method, as recited in claim 1, wherein the applying ultrasonic energy to the ceramic powder, provides an ultrasonic energy power greater than 1 W/cm².

16. The method, as recited in claim 1, further comprising:
removing the ceramic object from the press;
machining the ceramic object into a plasma chamber part; and
firing the ceramic object.

17. The method, as recited in claim 16, further comprising coating the ceramic object.

18. The method, as recited in claim 17, further comprising installing the object in a plasma processing chamber.

19. A method, comprising:
placing ceramic powder in a press;
applying pressure to the ceramic powder with a pressure to cause consolidation of the ceramic powder;
applying ultrasonic energy greater than 1 W/cm² to the ceramic powder for at least a period of time during the applying pressure to the ceramic powder, forming the ceramic powder into a ceramic object
heating the ceramic powder to a temperature above 1000° C. during at least a period of time during the applying pressure to the ceramic powder;
ending the applying pressure to the ceramic powder;
removing the ceramic object from the press;
machining the ceramic object into a plasma chamber part;
firing the ceramic object; and
installing the ceramic object as part of a plasma processing chamber.
